(19) United States
(12) Patent Application Publication
(10) Pub. No.: US 2023/0381951 A1
(43) Pub. Date: Nov. 30, 2023

(54) JOINT MECHANISM

(71) Applicant: TOYOTA JIDOSHA KABUSHIKI KAISHA, Toyota-shi (JP)

(72) Inventor: Kazutoshi NISHII, Toyota-shi (JP)

(73) Assignee: TOYOTA JIDOSHA KABUSHIKI KAISHA, Toyota-shi (JP)

(21) Appl. No.: 18/123,123

(22) Filed: Mar. 17, 2023

(30) Foreign Application Priority Data
May 31, 2022 (JP) 2022-088850

(51) Int. Cl. B25J 9/10

(52) U.S. Cl. CPC B25J 9/104

(57) ABSTRACT

The joint mechanism includes: a first joint portion; a second joint portion connected to the first joint portion via a connecting member so as to be relatively rotatable about an axis of the connecting member; a plurality of wires each having one end side arranged in a straight line and extending from the first joint portion toward the second joint portion, the other end side being attached to the second joint portion in a circumferential shape, and being pulled; and an offset member provided between the first joint portion and the second joint portion, the offset member being configured to offset one end side of the wire arranged in a straight line with respect to each other by passing the wire.

### CROSS-REFERENCE TO RELATED APPLICATION

This application claims priority to Japanese Patent Application No.

2022-088850 filed on May 31, 2022, incorporated herein by reference in its entirety.

### BACKGROUND

### 1. Technical Field

The present disclosure relates to a joint mechanism of, for example, a robot.

### 2. Description of Related Art

A joint mechanism is known that includes a first joint portion, a second joint portion connected to the first joint portion via a connecting member so as to be relatively rotatable about an axis of the connecting member, and a plurality of wires provided with one ends arranged linearly and extending from the first joint portion toward the second joint portion, and the other ends fixed to the second joint portion circumferentially and pulled (see, for example, Japanese Patent No. 6545768 (JP 6545768 B)).

### SUMMARY

However, in the above-described joint mechanism, there is a possibility that, when the second joint portion rotates relative to the first joint portion at a predetermined angle or more, the wires may interfere with each other.

The present disclosure has been made in view of the above issue, and it is a main object of the present disclosure to provide a joint mechanism capable of avoiding interference between the wires even when the second joint portion rotates relative to the first joint portion at a predetermined angle or more.

An aspect of the present disclosure for achieving the above object is a joint mechanism including: a first joint portion; a second joint portion connected to the first joint portion via a connecting member so as to be relatively rotatable about an axis of the connecting member; a plurality of wires provided with one ends arranged linearly and extending from the first joint portion toward the second joint portion, and the other ends each attached to the second joint portion circumferentially and pulled; an offset member that is provided between the first joint portion and the second joint portion and offsets the one ends of the wires arranged linearly from one another by passing the wires through the offset member.

In this aspect, the offset member may circumferentially offset the one ends of the wires arranged linearly.
In this aspect, the offset member may offset the one ends of the wires arranged linearly in a concentric manner with respect to a circle of the other ends of the wires when the other ends of the wires are fixed circumferentially.
In this aspect, the first joint portion may be an elbow joint portion of a robot, and the second joint portion may be a wrist joint portion of the robot.

According to the present disclosure, it is possible to provide a joint mechanism capable of avoiding interference between the wires even when the second joint portion rotates relative to the first joint portion at a predetermined angle or more.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a perspective view illustrating a schematic configuration of a joint mechanism according to the present embodiment;

FIG. 2A is a schematic view illustrating the interference of wires;

FIG. 2B is another view showing the interaction of wires;

FIG. 2C is another view showing the interaction of wires;

FIG. 3A is a top view of the wire from the elbow joint portion side to the wrist joint portion side;

FIG. 3B is another top view of the wires from the elbow joint portion side to wrist joint portion side;

FIG. 3C is another top view of the wires from the elbow joint portion side to the wrist joint portion side;

FIG. 4 is a view showing a state in which four wires are offset by an offset member;

FIG. 5 is a diagram illustrating a simulation result of interference of a wire according to the present embodiment;

FIG. 6 is a diagram illustrating simulated interference of wires according to the embodiment.

### DETAILED DESCRIPTION OF EMBODIMENTS

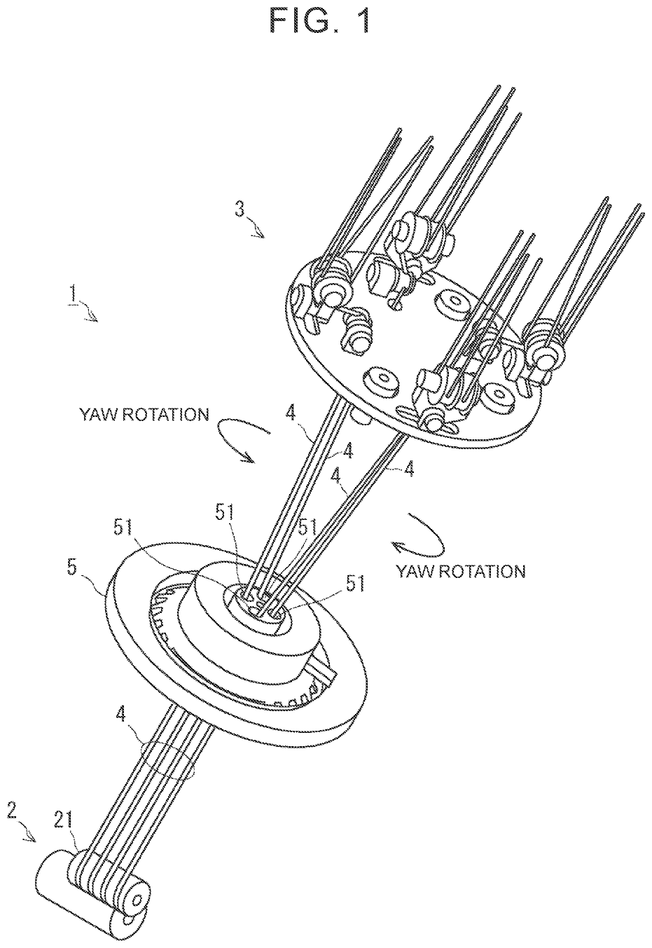

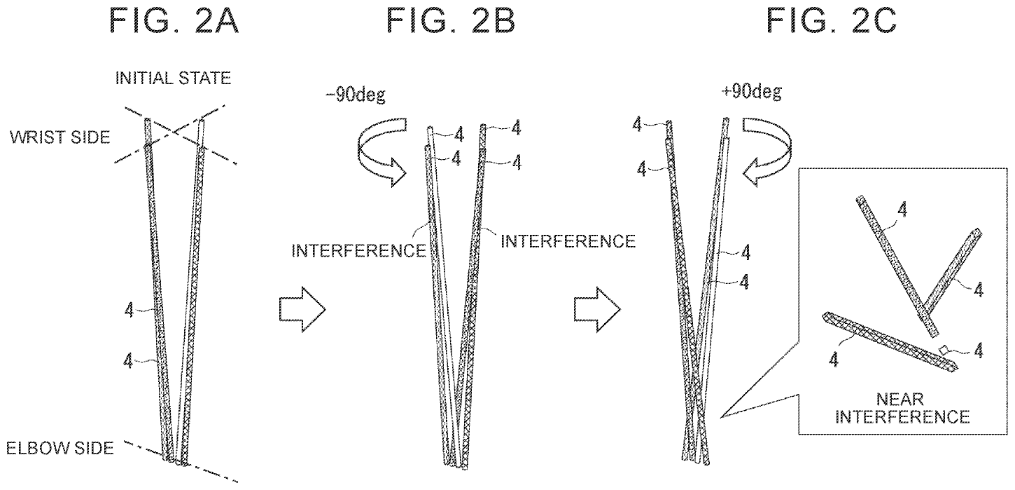

Hereinafter, embodiments of the present disclosure will be described with reference to the drawings. The joint mechanism according to the present embodiment is provided, for example, in a robot arm or the like. FIG. 1 is a perspective view illustrating a schematic configuration of a joint mechanism according to the present embodiment.

The joint mechanism 1 according to the present embodiment includes, for example, an elbow joint portion 2, a wrist joint portion 3 connected to the elbow joint portion 2 via a connecting member (not shown) so as to be relatively rotatable about an axis of the connecting member, and a plurality of wires 4 extending from the elbow joint portion 2 toward the wrist joint portion 3 and being pulled.

The elbow joint portion 2 is a specific example of the first joint portion. The wrist joint portion 3 is a specific example of the second joint portion. The connecting member is formed of, for example, a link, a frame, or the like. The wrist joint portion 3 is configured to be rotatable relative to the elbow joint portion 2 about the axis of the connecting member, that is, about the yaw axis.

For example, four wires 4 are provided from the elbow joint portion 2 to the wrist joint portion 3. In the present embodiment, four wires 4 are provided, but the present disclosure is not limited thereto, and any number of wires 4 may be provided.

The elbow joint portion 2 is provided with a pulley 21. One end side of each wire 4 is wound around the pulley 21. Therefore, one end side of each wire 4 is aligned in a straight line at a predetermined interval, and extends from the pulley 21 of the elbow joint portion 2 toward the wrist joint portion 3. On the other hand, the other end side of each wire 4 is circumferentially attached to the end portion of the wrist joint portion 3. When one end side of each wire 4 is pulled, for example, the wrist joint portion 3 is configured to be rotationally driven around a roll axis or a pitch axis.

Here, conventionally, as shown in 2A, in the arrangement of the four wires 4, when the wrist side is relatively rotated about the yaw axis with respect to the elbow side, there is a possibility that the wires 4 interfere with each other. Therefore, the rotational range around the yaw shaft is limited to the range of 180 deg from-90 deg shown in the drawing 2B to the +90 deg shown in the drawing 2C.

However, the rotation range around the yaw axis of the wrist joint with respect to the elbow joint in an actual human is of a 270 deg degree, and it is desired to realize a wider rotation range around the yaw axis than described above.

On the other hand, as shown in FIG. 1, the joint mechanism 1 according to the present embodiment further includes an offset member 5 that is provided between the elbow joint portion 2 and the wrist joint portion 3, and that offsets one end side of the wire 4 arranged linearly with respect to each other by passing the wire 4.

Between the elbow joint portion 2 and the wrist joint portion 3, the offset member 5 offsets the wire 4 so as to avoid interference between the wires 4 even when the wrist joint portion 3 is rotated relative to the elbow joint portion 2 at a certain angle or more. Therefore, even if the wrist joint portion 3 is relatively rotated with respect to the elbow joint portion 2 at a certain angle or more, interference between the wires 4 can be avoided.

The offset member 5 is a substantially cylindrical member, four through holes 51 are formed in a circumferential shape corresponding to the four wires 4, respectively. The through hole 51 extends in the yaw axis direction. Each wire 4 extending from the pulley 21 of the elbow joint portion 2 passes through the through-hole 51 of the offset member 5 to be circumferentially offset. The circumferentially offset wire 4 extends in that state and is circumferentially attached to the wrist joint portion 3.

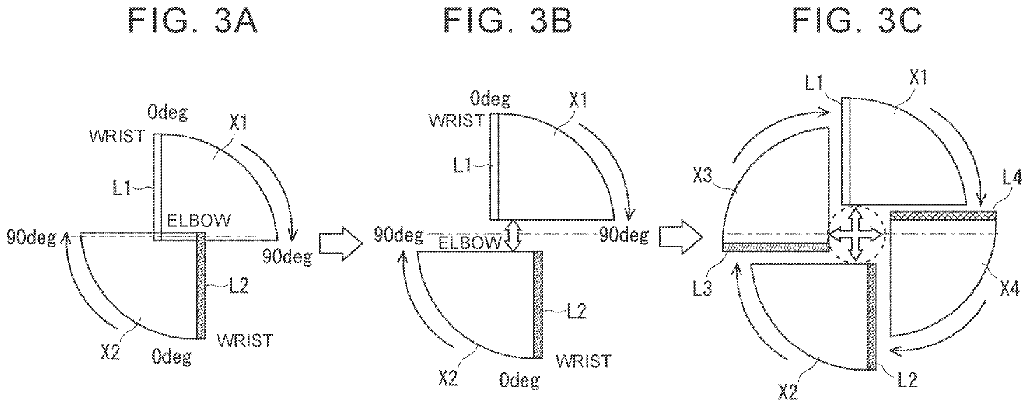

Next, the above-described method of offsetting the wire 4 will be described in detail. FIGS. 3A to 3C are top views of a wire from an elbow joint portion side to a wrist joint portion side.

First, for the sake of clarity, we assume that two wire L1, L2 are offset. As shown in 3A, when the wrist joint portion 3 is rotated 90 deg to the elbow joint portion 2 about the yaw axis, the operating region X1 of the wire L1 and the operating region X2 of the wire L2 overlap each other due to the thickness of the wire L1, L2, and interfere with each other.

On the other hand, as shown in 3B, the elbow joint portion side ends of the wire L1, L2 are offset apart from each other. In this case, the wire L1 and the wire L2 do not interfere with each other because an area where the operation region X1 of the wire L1 overlaps with the operating region X2 of the wire L2 does not occur.

Next, an offset of four wire L1, L2, L3, L4 is assumed. As shown in 3C, the elbow joint portion side ends of the wire L1, L2, L3, L4 are circumferentially offset apart from each other. In this case, there is no region in which the operation region X1 of the wire L1, the operation region X2 of the wire L2, the operation region X3 of the wire L3, and the operation region X4 of the wire L4 overlap. Wiring L1, L2, L3, L4 do not interfere with each other.

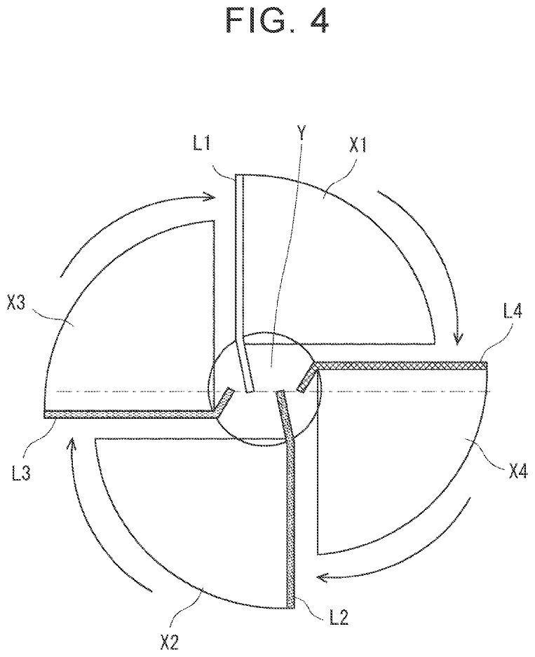

FIG. 4 is a diagram illustrating a state in which four wires are offset by the offset member.

The four wire L1, L2, L3, L4 extend from the pulley 21 of the elbow joint portion 2 toward the wrist joint portion 3 in a straight line.

As described above, in the offset member 5 provided between the wrist joint portion 3 and the elbow joint portion 2, four through holes are formed in a circumferential shape corresponding to the wire L1, L2, L3, L4. Therefore, the wire L1, L2, L3, L4 extending from the pulley 21 of the elbow joint portion 2 passes through the through-hole and is circumferentially offset. The wire L1, L2, L3, L4 extends to the wrist joint portion 3 in a circumferentially offset manner, and the other end is attached to the wrist joint portion 3 in a circumferentially shaped manner.

Incidentally, the offset member 5, one end side of the wire L1, L2, L3, L4 arranged in a straight line, it is preferable to offset the other end side of the wire L1, L2, L3, L4 concentrically with the circle when fixed to the wrist joint portion 3 circumferentially. Accordingly, even if the wrist joint portion 3 is relatively rotated at a certain angle or more with respect to the elbow joint portion 2, the wire L1, L2, L3, L4 can be prevented from interfering with each other.

The offset member 5 is fixed to, for example, a link. Therefore, when the wrist joint portion 3 is relatively rotated about the yaw axis with respect to the elbow joint portion 2, the part Y of the wire L1, L2, L3, L4 from the pulley 21 to the offset member 5 of the elbow joint portion 2 does not operate as shown in FIG. 4, and therefore does not interfere with each other.

On the other hand, the part of the wire L1, L2, L3, L4 from the offset member 5 to the wrist joint portion 3 operates within the operating area. However, as described above, since the offset member 5 is offset circumferentially, as shown in FIG. 4, the operation region X1 of the wire L1, the operation region X2 of the wire L2, the operation region X3 of the wire L3, and the operation region X4 of the wire L4 do not overlap. Wiring L1, L2, L3, L4 do not interfere with each other.

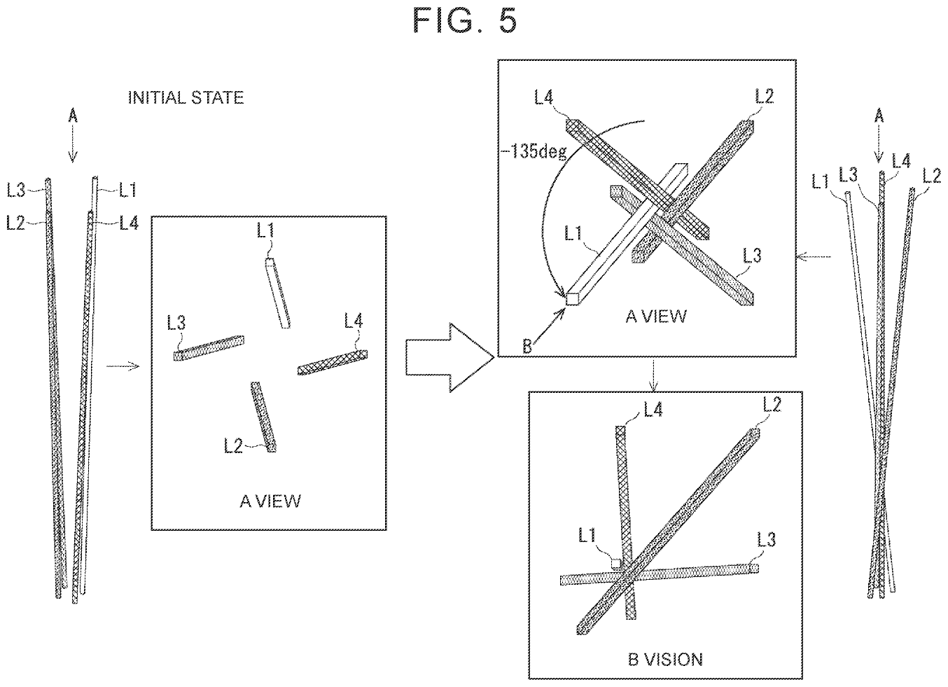

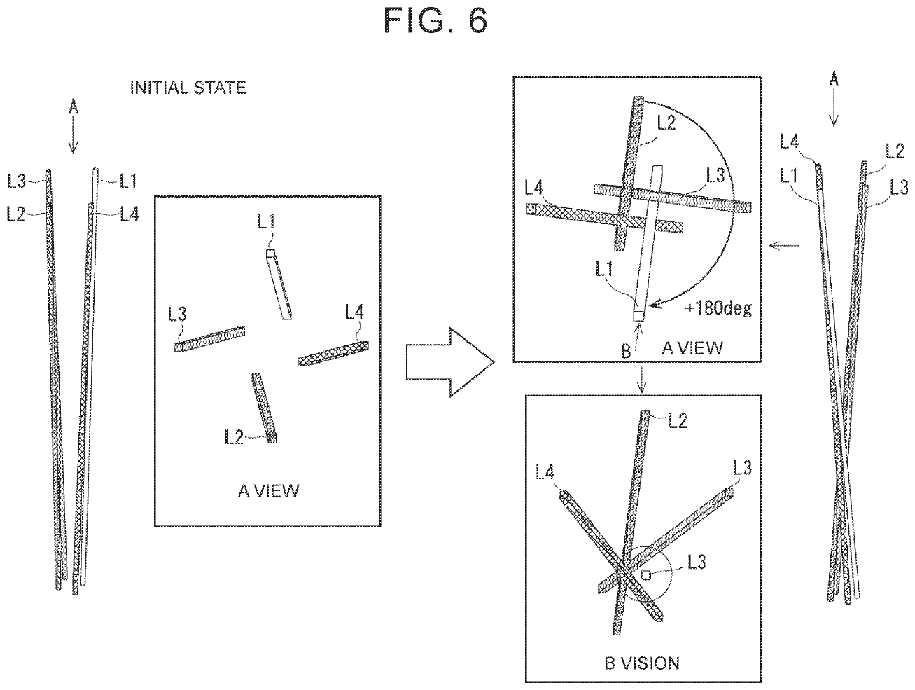

FIG. 5 and FIG. 6 are diagrams showing simulation results of the interference of the wire according to the present embodiment. In FIGS. 5 and 6, the left side of the arrow is a diagram showing an initial state of the wire L1, L2, L3, L4, and the right side of the arrow is a diagram showing a state after the operation of the wire L1, L2, L3, L4. FIG. 5 is a view in which each wire L1, L2, L3, L4 is rotated in a counterclockwise direction, and FIG. 6 is a view in which each wire L1, L2, L3, L4 is rotated in a clockwise direction.

As shown in FIG. 5, it can be seen from the initial-state that the wire L1, L2, L3, L4 can be prevented from interfering with each other even if the wrist joint portion 3 is relatively rotated about the yaw shaft with respect to the elbow joint portion 2 and the wire L1, L2, L3, L4 are rotated counterclockwise by an-135 deg.

Similarly, as shown in FIG. 6, it can be seen that, from the initial state, the wrist joint portion 3 is relatively rotated about the yaw axis with respect to the elbow joint portion 2, and the wire L1, L2, L3, L4 are rotated clockwise by +180 deg to avoid interfering with each other in the wire L1, L2, L3, L4. As described above, the wire L1, L2, L3, L4 can be prevented from interfering with each other even if the wrist joint portion 3 is rotated around the yaw shaft in a wide range of −135 deg˜+180 deg (angular range 315 deg) with respect to the elbow joint portion 2 by offsetting the wires L1, L2, L3, L4 in a circumferential manner using the offset member 5 according to the present embodiment.

As described above, the joint mechanism 1 according to the present embodiment further includes the offset member 5 that is provided between the elbow joint portion 2 and the wrist joint portion 3, and that offsets one end side of the wire 4 arranged in a straight line from one another by passing the wire 4. Accordingly, even if the wrist joint portion 3 is relatively rotated at a certain angle or more with respect to the elbow joint portion 2, interference between the wires 4 can be avoided.

Although some embodiments of the present disclosure have been described, these embodiments are presented as examples and are not intended to limit the scope of the disclosure. These novel embodiments can be implemented in various other embodiments, and various omissions, replacements, and changes can be made without departing from the gist of the disclosure. These embodiments and modifications thereof are included in the scope and gist of the disclosure, and are also included in the disclosure described in the claims and the equivalent thereof.

What is claimed is:

1. A joint mechanism comprising:
a first joint portion;
a second joint portion connected to the first joint portion via a connecting member so as to be relatively rotatable about an axis of the connecting member;
a plurality of wires provided with one ends arranged linearly and extending from the first joint portion toward the second joint portion, and the other ends each attached to the second joint portion circumferentially and pulled;
an offset member that is provided between the first joint portion and the second joint portion and offsets the one ends of the wires arranged linearly from one another by passing the wires through the offset member.

2. The joint mechanism according to claim 1, wherein the offset member circumferentially offsets the one ends of the wires arranged linearly.

3. The joint mechanism according to claim 2, wherein the offset member offsets the one ends of the wires arranged linearly in a concentric manner with respect to a circle of the other ends of the wires when the other ends of the wires are fixed circumferentially.

4. The joint mechanism according to claim 1, wherein the first joint portion is an elbow joint portion of a robot, and the second joint portion is a wrist joint portion of the robot.
